(19) United States
(12) Patent Application Publication
(10) Pub. No.: US 2025/0284939 A1
(43) Pub. Date: Sep. 11, 2025

(54) SPIKING NEURAL NETWORKS

(71) Applicant: RUTGERS, THE STATE UNIVERSITY OF NEW JERSEY, New Brunswick, NJ (US)

(72) Inventors: Dario Pompili, Hillsborough, NJ (US); Yung-Ting Hsieh, Piscataway, NJ (US)

(21) Appl. No.: 19/075,144

(22) Filed: Mar. 10, 2025

Related U.S. Application Data
(60) Provisional application No. 63/563,432, filed on Mar. 10, 2024.

(51) Int. Cl. G06N 3/049

(52) U.S. Cl. CPC G06N 3/049

(57) ABSTRACT

A spiking neural network is provided, wherein each neuron of the spiking neural network includes a RC or RLC circuit formed of passive elements. The RC or RLC circuit provides a corresponding spiking function. In some cases, a portion of each neuron of the spiking neural network is implemented in a digital processor and further includes a digital to analog converter between the portion implemented in the digital processor and the RC or RLC circuit. In some cases, the spiking neural network is implemented as a fully analog neural network.

### CROSS-REFERENCE TO RELATED APPLICATION(S)

This application claims the benefit of U.S. Provisional Patent Application No. 63/563,432, filed Mar. 10, 2024.

### GOVERNMENT SUPPORT

This invention was made with government support under Grant No. 1937403 awarded by the National Science Foundation (NSF RTML). The Government has certain rights in the invention.

### BACKGROUND

Neural network-based classifiers continue to play a pivotal role in a variety of applications, from computer vision to health monitoring. In a number of applications, the size and power consumption of the neural network can be limiting. Therefore, there continues to be a need in the art for improvements to power efficiency and scalability such that hardware resource requirements can be satisfied for a given application.

### BRIEF SUMMARY

Spiking neural networks are described that can be incorporated as part of larger neural network designs for a variety of machine learning applications. Spiking neural networks emulate biological neural processes, leveraging features such as electrical synapses. Spiking neural networks employ sparce firing patterns, where only a subset of neurons (or their modeled equivalent) are active at a given time, which reduces overall energy demands.

In certain embodiments, a spiking neural network is provided, wherein each neuron of the spiking neural network includes a RC or RLC circuit formed of passive elements. The RC or RLC circuit provides a corresponding spiking function. An RC circuit comprises a Resistor (R) and a Capacitor (C) connected in series or parallel. An RLC circuit consists of a resistor, an inductor, and a capacitor connected in series or parallel.

In some cases, a portion of each neuron of the spiking neural network is implemented in a digital processor and further includes a digital to analog converter between the portion implemented in the digital processor and the RC or RLC circuit.

In some cases, the spiking neural network is implemented as a fully analog neural network.

The described spiking neural networks can be used as a classifier.

In certain embodiments, an analog signal processing circuit is provided that includes: a current mirror; a multiplier coupled to the current mirror and receiving, at an amplifier input of the current mirror, an output of a spike neuron of a spiking neural network; an integrator coupled to an output of the multiplier; and a comparator circuit coupled to an output of the integrator to compare with reference values. Such an analog signal processing circuit can be used in other applications and receive other inputs at the amplifier input of the current mirror.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example hardware for a spiking neural network.

FIG. 2A shows a textbook representation of a biological neuron.

FIG. 2B shows a conceptual diagram of synaptic transmission of a signal from one neuron to another.

FIGS. 3A-3C show example equivalent analog circuits for spiking neuron models.

FIGS. 4A-4D show the impulse response of an RC and RLC series circuit with 200Ω resistor, 10 mH inductor conductance, and 1.56 μF capacitor capacitance.

FIG. 5A illustrates an example hardware for a spiking neural network.

FIG. 5B shows an example representation of a neural network that can be implemented by the hardware of FIG. 5A.

FIG. 6A shows an example representation of an analog neural network with spiking function.

FIG. 6B shows an example implementation of a single voltage-based resistive processing unit (VRPU).

FIG. 6C shows an example implementation of a voltage adder.

FIG. 6D shows a model of a cross-correlation circuit.

FIG. 6E shows an analog circuit for one use case of the model of FIG. 6D.

FIGS. 7A and 7B respectively illustrate fire responses for when the spike response function circuit is implemented as a LIF (FIG. 3C) and DE (FIG. 3A).

FIG. 8 illustrates an example artificial neural network architecture that can be converted to incorporate a spiking neural network.

FIGS. 9A-9C present confusion matrices for comparison of a traditional SNN fully applied on a hardware-limited device with the proposed hybrid SNN on the MNIST dataset for image classification. FIG. 9A shows the performance of a SNN without analog help with limited FPGA hardware resources to run both the neural network and the impulse function; FIG. 9B shows the performance of a SNN with analog help for the operation of 2−e^{-x}, using the impulse response of a charge RC circuit, and the limited FPGA hardware resources; and FIG. 9C shows the performance of a SNN with analog help for the operation of e^{-x} sin(x), using the impulse response of an underdamped RLC circuit, and the limited FPGA hardware resources.

FIG. 10 shows the accuracy of the hybrid SNN using different spike response functions e^{-x}, 2−e^{-x}, e^{<2x} sin(x), and e^{-2x} sin(x) on the MNIST dataset over 20 epochs.

FIGS. 11A-11C present confusion matrices for comparison of a traditional SNN fully applied on a hardware-limited device with the proposed hybrid SNN on the CIFAR10 dataset for image classification. FIG. 11A shows the performance of a SNN without analog help with limited FPGA hardware resources to run both the neural network and the impulse function; FIG. 11B shows the performance of a SNN with analog help for the operation of 1−e^{-x}, using the impulse response of a charge RC circuit; and FIG. 11C shows the performance of a SNN with analog help for the operation of e^{-x} sin(x), using the impulse response of an underdamped RLC circuit.

FIG. 12 shows the accuracy of the hybrid SNN over a pure digital STDP using different spike response functions on the CIFAR10 dataset over 20 epochs.

FIG. 13 shows the accuracy of the hybrid SNN over a pure digital STDP using different spike response functions on the SVHN dataset over 20 epochs.

FIG. 14 illustrates the comparison of power consumption, added power, and increased performance among various FPGAs that run ANN-SNN aided analogously with the SVHN dataset.

FIGS. 15A and 15B show confusion matrices for Fashion MNIST image classification using an analog SNN to operate impulse responses of RC circuits and underdamped RLC circuit, respectively.

FIG. 16 shows the accuracy of the analog SNN with various spike response functions on the Fashion MNIST dataset over 20 epochs.

FIG. 17 shows a schematic illustration of a force-controlled resettable single-molecule DNA computing system.

FIG. 18A shows the original MNIST image.

FIG. 18B compares the original and spiking-modulated images across 50 samples from the MNIST dataset.

FIG. 18C presents the spiking-modulated image using the traditional LIF model.

FIG. 18D illustrates the wavelet-transformed image with [symbol] 1-norm regularization, which is more effective at noise reduction while still preserving the overall shape of the image.

### DETAILED DESCRIPTION

Spiking neural networks are described that can be incorporated as part of larger neural network designs for a variety of machine learning applications.

Spiking Neural Networks (SNNs), inspired by biological neural networks, offer energy-efficient and temporally encoded solutions. SNNs capitalize on sparse neural activity, reducing energy consumption and computational demands, and making them attractive for real-world applications. For example, various implementations of the described neural networks are suitable for applications in real-time computer vision for smart cameras, drones, autonomous vehicles, and collaborative robots.

Indeed, the higher sparsity signals of the SNN operation result in more energy efficiency because when a next neuron is not fired, there is no power consumption at this resting neuron. In addition, different spiking models can have different effects on the sparsity of the signals among neurons, which leads to different power savings ability and different classification performance.

As will be apparent by the description herein, it is possible to take advantage of passive analog circuits to offload tasks from digital hardware resources. This can help to build larger neural networks than those constrained by certain digital hardware resources.

Furthermore, compared with the conventional neural network where every neuron is consuming energy full time, the use of a SNN provides the opportunity to make a larger sized neural network when constrained by available energy resources. As briefly mentioned above, different spiking models lead to different sparsity in the signals. In addition, for different spiking models, different tasks can have different sparsity. Therefore, energy savings can be based on spiking model selection in light of the tasks being performed.

A neural network hardware is provided herein that implements a spike response function using analog circuitry. In some cases, the network of the neural network is hosted on a field programmable gate array (FPGA) and the spike response function for each neuron is housed on an analog chip that is in communication with the FPGA. In some cases, an all-analog network can be implemented using voltage-based resistive processing units (VRPU) and spike response analog circuitry.

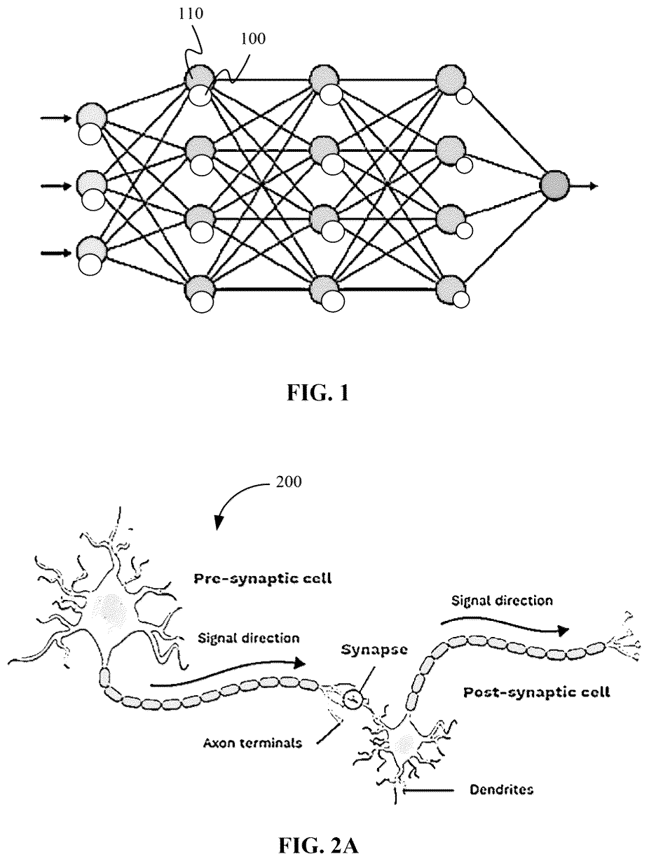

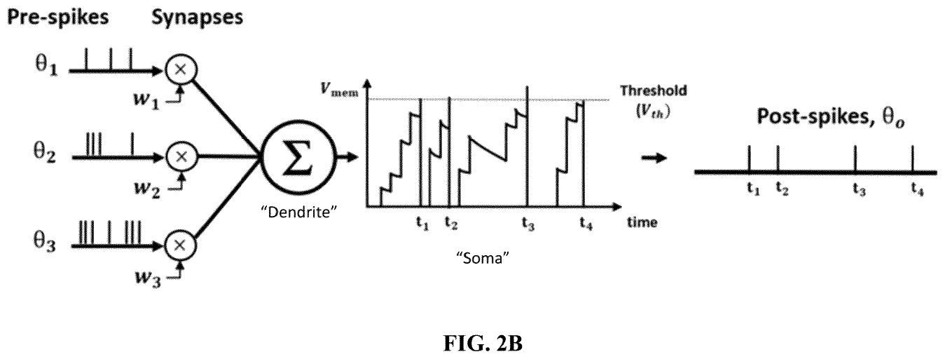

FIG. 1 shows an example representation of a neural network with a spike response function in a layer. Referring to FIG. 1, it can be seen that a spike response function 100 is applied at cach neuron 110. The spike response function is based on emulating the human brain—even borrowing from the terms used to describe the nervous system. FIG. 2A shows a textbook representation of a biological neuron. For example, with reference to a biological neuron such as shown in FIG. 2A, a neuron 200 is the fundamental signaling unit of the nervous system, consisting of four morphologically defined parts: the soma, dendrites, axon, and the presynaptic terminal. Synapses are specialized structures that allow one neuron to communicate with another. Synapses include a presynaptic membrane, a synaptic cleft, and a postsynaptic membrane. The average neuron forms thousands of synaptic connections with neighboring neurons. Synaptic transmission is essential for brain functions such as perception, learning, and memory. Two modes of synaptic transmission are electrical and chemical. Electrical synapses use gap junctions for direct action potential transmission, whereas chemical synapses rely on neurotransmitters. Electrical synapses have low resistance and rapid bidirectional propagation, while chemical synapses depend on neurotransmitters stored in synaptic vesicles such as acetylcholine, amino acids, catecholamines, and neuropeptides.

FIG. 2B shows a conceptual diagram of synaptic transmission of a signal from one neuron to another. Referring to FIG. 2B, it can be seen that synapses may be considered to operate based on an input pre-spike (θ₁, θ₂, θ₃) combined with a corresponding weight (w₁, w₂, w₃). When the activity results in a value (e.g., voltage value) above a firing threshold, the neuron will fire, outputting post spikes, θo, over time. In this manner, SNNs can be created that emulate the human brain, employing sparse neural activity and a firing threshold, which enhances energy efficiency and computational requirements. Notably, SNNs encode information sparsely, differing from artificial neural networks where most neurons remain active at every time step.

In exploring synaptic, or spiking neuron, models, three metaphors provide insightful connections to different aspects of neural communication. These models balance biological accuracy and computational feasibility. The Double-Exponential Synapse Metaphor mirrors the adaptive weight adjustment seen in electrical synapses, where gap junctions facilitate direct electrical signaling between neurons. Moving to the Hodgkin-Huxley Synapse Metaphor, the intricate dynamics of ion channels find a parallel in neuromuscular junctions, where neurotransmitter release and ion channel activities orchestrate muscle contraction. Finally, the Leaky Integrate-and-Fire synapse metadata aligns with inhibitory ion channel synapses, demonstrating how cumulative evidence integration regulates neuron excitability by preventing excessive firing through hyperpolarization. These metaphors offer valuable information about the diverse mechanisms that underlic neural communication.

Based on these models, equivalent analog circuits of RC and RLC circuits can be used and selected to implement a spiking neuron model behavior. An RC circuit comprises a Resistor (R) and a Capacitor (C) connected in series or parallel. An RLC circuit consists of a resistor, an inductor, and a capacitor connected in series or parallel.

In some embodiments, analog circuitry can include cross-correlation circuits and oscillator-based circuits to perform wavelet transforms, enabling efficient time-frequency domain encoding in the spiking model, which is inspired by biological sensory encoding.

To elaborate, biological systems exhibit frequency-domain transformations at the neural and synaptic levels. For example, in both visual and auditory pathways, neurons are capable of processing signals in the time-frequency domain. In the visual system, certain cells in the retina and visual cortex perform localized frequency analysis, allowing the brain to detect edges, patterns, and textures. Similarly, in the auditory system, cochlear neurons break down incoming sounds into frequency components, a process analogous to wavelet transformations. These mechanisms enable biological systems to efficiently encode complex stimuli across both time and frequency, optimizing signal representation or denoising for further neural processing.

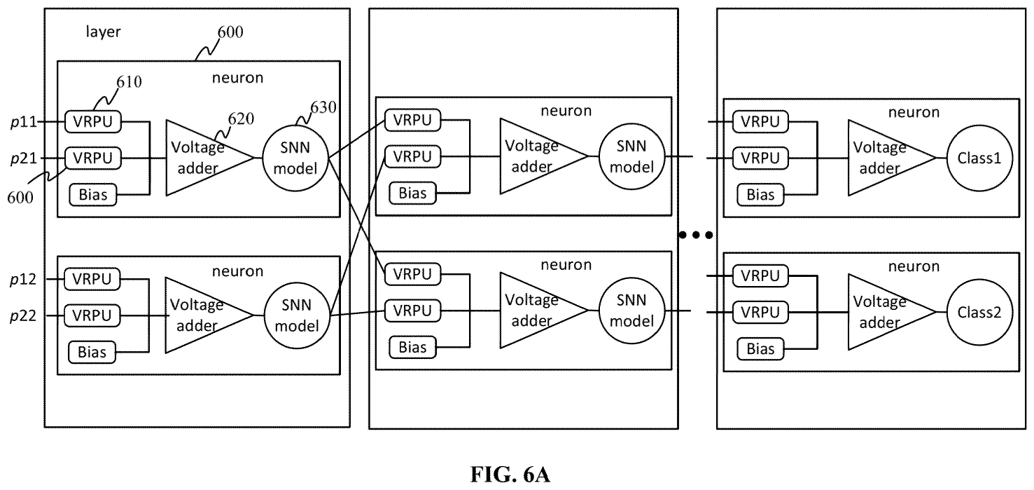

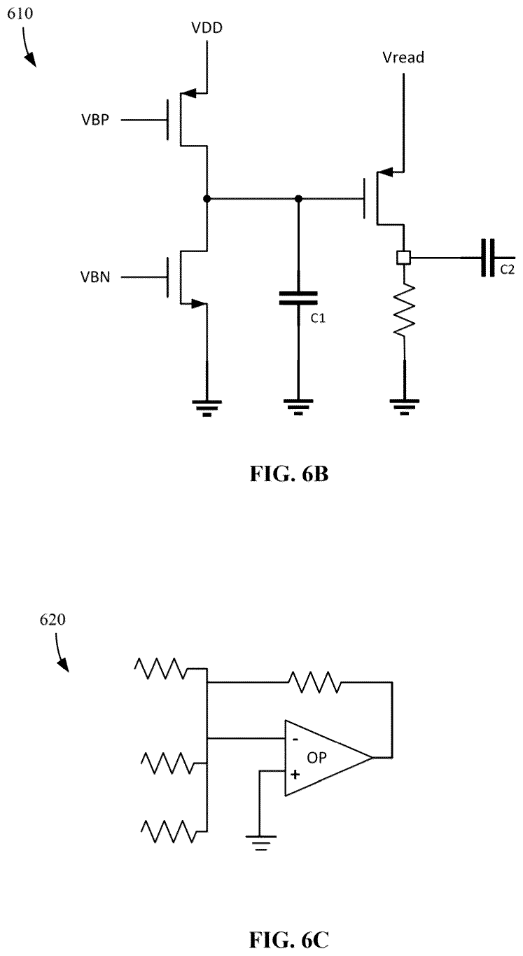

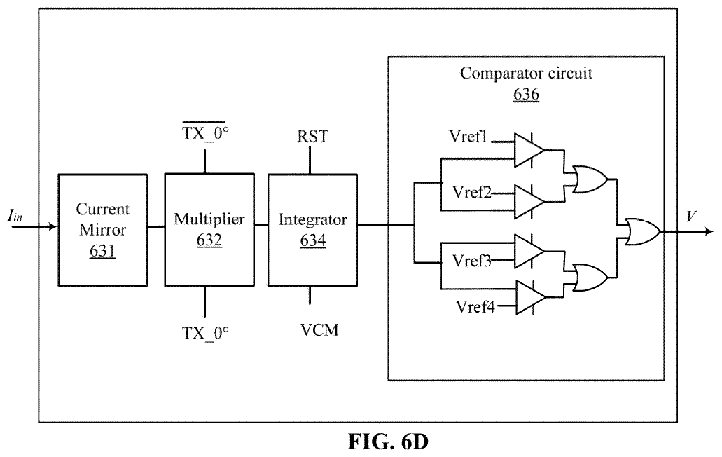

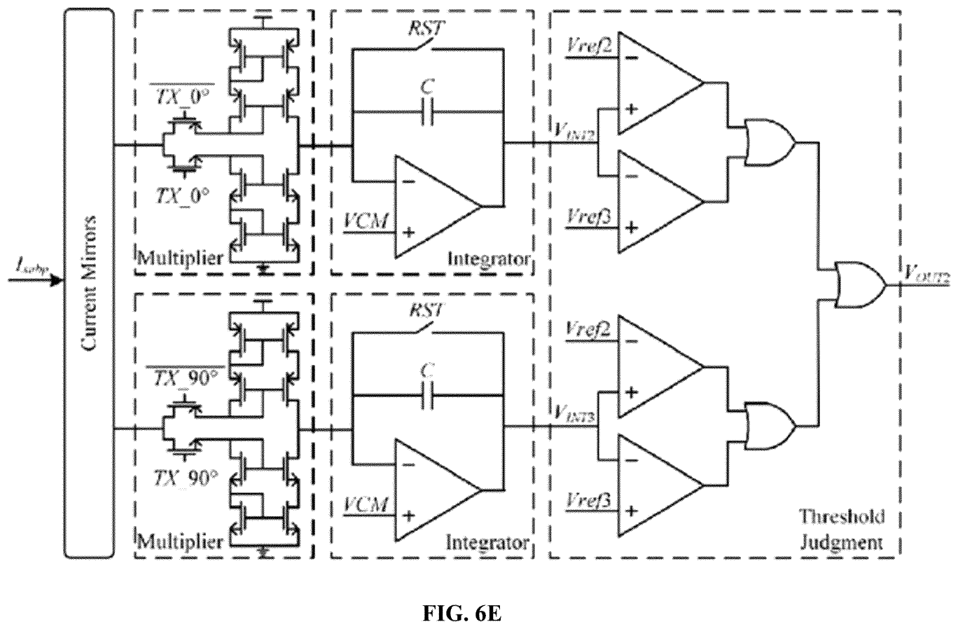

Analog circuits performing wavelet transforms based on biological systems can include a current mirror, a multiplier coupled to the current mirror, an integrator coupled to an output of the multiplier and a comparator circuit coupled to an output of the integrator (see FIGS. 6D and FIG. 6E).

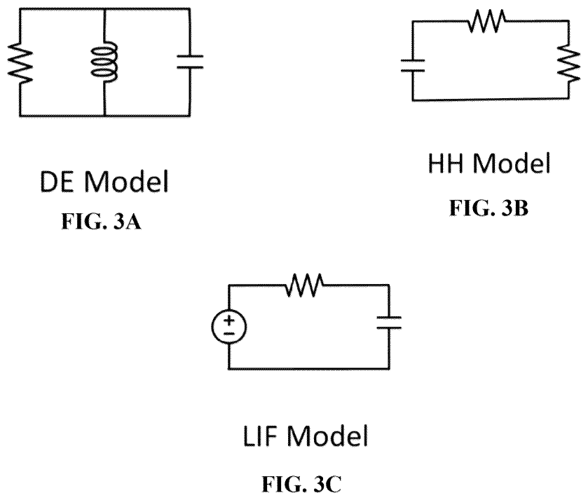

FIGS. 3A-3C show example equivalent analog circuits for spiking neuron models. Referring to FIG. 3A, the Double-Exponential (DE) model captures post-synaptic cell (PSC) decay and rise, similar to an over-damped RLC circuit. Referring to FIG. 3B, the HH model is based on Hodgkin and Huxley's experiments on the giant axon of a squid, which revealed the involvement of the K+ and Na+ channels in the generation of action potentials. The HH model uses ordinary differential equations (ODEs) to represent ion channels and incorporates terms that account for channel behavior, described as opening and closing gates despite changes in permeability due to structural protein changes. Referring to FIG. 3C, the leaky integrate-and-fire (LIF) model accumulates input current that charges the membrane until it reaches a threshold and includes a “leak” term for ion diffusion through the membrane. As can be seen, the spiking neuron models can be formed of passive elements and thus can be implemented as part of an analog circuit.

The spiking dynamics within the SNN, adaptable for the implementation of potential analog circuits, are governed by a spike response function derived from the Double Exponential (DE) model, Hodgkin-Huxley (HH) model, or Leaky Integrate-and-Fire (LIF) model. These functions show changes in membrane potential over time in response to incoming spikes and can be expressed as follows.

For the DE model:

$$f ( t ) = A ( {e}^{- \frac{t}{{τ}_{d}}} - {e}^{- \frac{t}{{τ}_{r}}} )$$

$$A = \frac{{τ}_{d}}{{τ}_{d} - {τ}_{r}} {( \frac{{τ}_{r}}{{τ}_{d}} )}^{\frac{{τ}_{r}}{{τ}_{r} - {τ}_{d}}}$$

Here, A represents the normalizing constant, τd is the synaptic decay time constant, and τr stands for the synaptic rising time constant.

For the HH model:

$${C}_{m} \frac{d {υ}_{m} ( t )}{dt} {I}_{ion} ( t ) + {I}_{syn} ( t )$$

Here, Cm is membrane capacitance (pF), vm is the membrane potential (mV), and Isyn is synaptic input current (pA).

For the LIF model:

$${υ}_{m} ( t ) = {R}_{m} I ( 1 - {e}^{- \frac{t}{{τ}_{m}}} )$$

Here, Rm denotes the membrane resistance (in megaohms), and τm represents the membrane time constant, calculated as τm=RmCm. The neuron emits a spike when the membrane potential reaches the threshold.

These models can form the basis of an analog passive circuit for spike response. Artificial Neural Networks (ANNs) process dense analog-valued inputs in a single input flow, whereas SNN processes sparse binary inputs (spikes) over time. Consequently, different neuron models are used in ANNs and SNNs. An RC circuit comprises a Resistor (R) and a Capacitor (C) connected in series or parallel. When connected to a voltage source, the capacitor charges to the source voltage through the resistor and discharges when the source is disconnected. The voltage across the capacitor over time is described by the following equations.

For the charging phase:

$${V}_{c} = {V}_{s} ( 1 - {e}^{- \frac{t}{RC}} )$$

where Vs is the source voltage, R is resistance, C is capacitance, t is time, and e is the mathematical constant.

For the discharging phase:

$${V}_{c} = {V}_{0} {e}^{- \frac{t}{RC}} )$$

where V0 is the initial capacitor voltage at disconnection.

The time constant, τ=RC, represents the time it takes for the capacitor to charge or discharge to approximately 63.2% of the applied voltage. RLC oscillation circuits consist of a resistor, inductor, and capacitor. The impulse response of the RLC circuit, a solution of an Ordinary Differential Equation (ODE), serves as an ideal spike response function for SNNs.

The following second-order differential equation governs the circuit's behavior:

$$\frac{{d}^{2} V}{{dt}^{2}} + \frac{R}{L} \frac{dV}{dt} + \frac{1}{LC} V = \frac{1}{LC} {V}_{in}$$

where V represents the capacitor voltage, Vin is the input voltage, L denotes inductance, C is capacitance, and R stands for resistance.

The roots of the characteristic equation determine the damping ratio of the circuit, denoted by η, which is the actual damping coefficient ratio to the critical damping coefficient.

For the overdamped case, where roots are real and distinct, with η>1, the circuit response is slow and smooth. The general solution is,

$$V ( t ) = {A}_{1} {e}^{- \frac{R}{2 L} t} + {A}_{2} {e}^{- \frac{1}{2 RC} t}$$

where A1 and A2 are constants determined by initial conditions.

In the underdamped scenario, with complex conjugate roots and η<1, the circuit response oscillates. The general solution is,

$$V ( t ) = {e}^{- \frac{R}{2 L} t} ( {A}_{1} cos {ω}_{d} t + {A}_{2} sin {ω}_{d} t )$$

where A1 and A2 are constants determined by initial conditions, and ωd is the damped natural frequency,

$${ω}_{d} = \sqrt{\frac{1}{LC} - {( \frac{R}{2 L} )}^{2}}$$

An RLC circuit consists of a resistor, an inductor, and a capacitor connected in series or parallel. When a pulse of voltage is applied to the circuit, the capacitor begins to charge and discharge through the inductor and resistor, causing the current to oscillate back and forth. The impulse response of the circuit describes the behavior of the circuit during this oscillation.

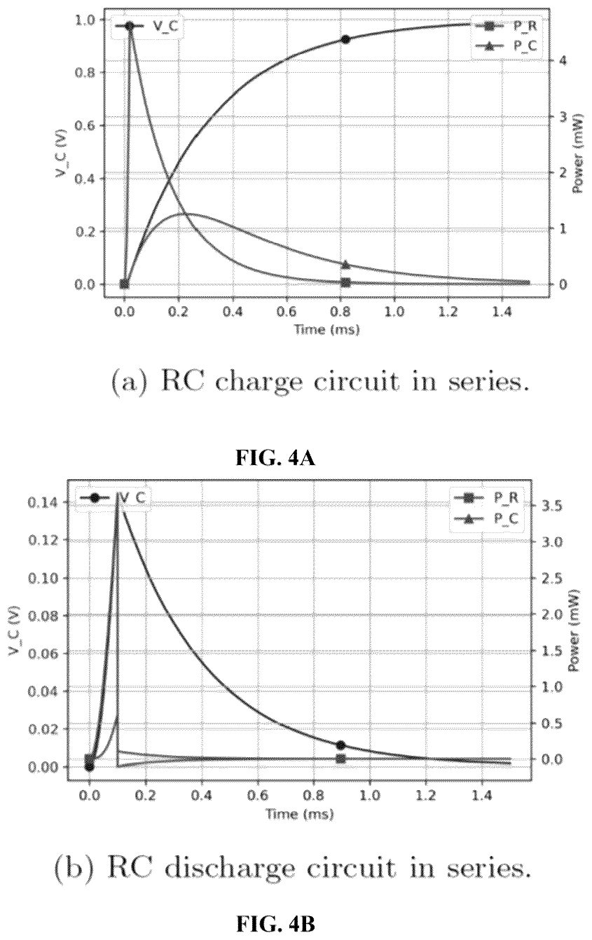

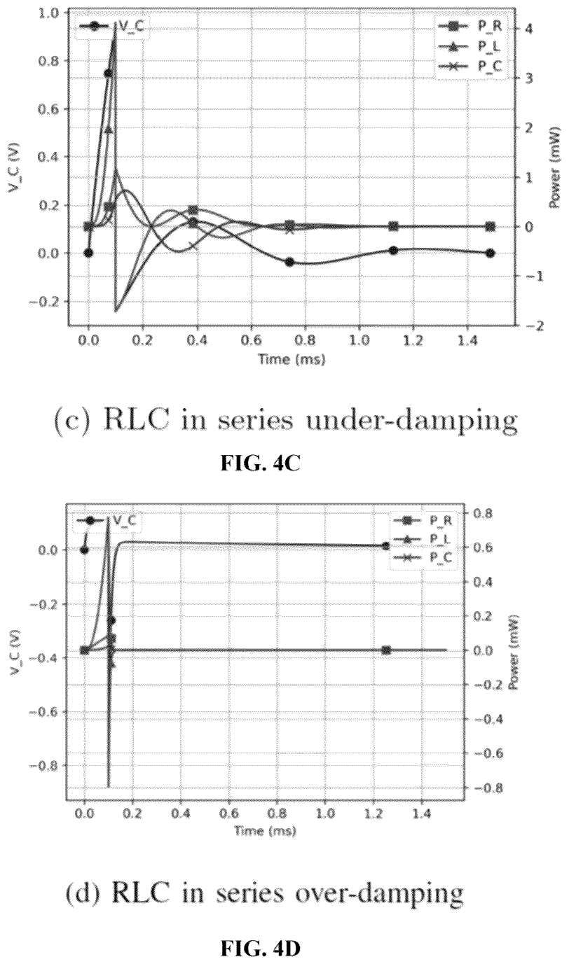

In terms of digital mathematical modeling, the analog impulse response of an RLC circuit can be described using differential equations. Solving these equations allows the calculation of the circuit's behavior over time, including the voltage and current at any given moment. FIGS. 4A-4D show the impulse response of an RC and RLC series circuit with 200Ω resistor, 10 mH inductor conductance, and 1.56 μF capacitor capacitance. Referring to FIG. 4A, which shows plots of an RC charge circuit in series, the circuit in the RC series is charged with 5V in which the behavior is

$${υ}_{c} ( t ) = {V}_{s} ( 1 - {e}^{- \frac{t}{RC}} )$$

where vc(t) is the voltage across the capacitor at time t, Vs is the source voltage, which is the impulse, R is the resistance, C is the capacitance. Referring to FIG. 4B, which shows RC discharge circuit in series, the RC series circuit is sparked by a 5V impulse, in which the circuit behavior is

$$\text{?} ( t ) = \text{?} {e}^{- \frac{t}{RC}} .$$

$$\text{?} \text{indicates text missing or illegible when filed}$$

To analyze the behavior of an RLC series circuit, we need to determine its damping ratio (ζ) which characterizes the decay rate of the circuit's oscillations. The damping ratio is defined as the ratio of resistance to twice the square root of the product of inductance and capacitance, as given by the equation

$$ζ = \frac{R}{2 \sqrt{\frac{L}{C}}} .$$

In the given circuit, R=50Ω, L=10 mH, and C=1.56 μF. Substituting these values into the equation for ζ one gets

$$ζ \text{?} \frac{50}{2 \text{?}} \text{?} \approx \text{?} 0. \text{?} 12.$$

$$\text{?} \text{indicates text missing or illegible when filed}$$

Since the damping ratio ζ is less than 1, the circuit is underdamped, meaning that the oscillations will decay exponentially with a characteristic frequency determined by the values of L, C, and R. The response is shown in FIG. 4C, which shows RLC in series under-damping.

To adjust the damping ratio, the simplest way is to increase the value of resistance. The damping ratio is given by the equation:

$$ζ \text{?} \frac{R}{2 \text{?} \frac{L}{C}} .$$

$$\text{?} \text{indicates text missing or illegible when filed}$$

To find the minimum value of resistance needed for the circuit to be overdamped, one can rearrange the equation to solve for R:

$$R \text{?} = 2 \text{?} \sqrt{\frac{L}{C} \text{?}} .$$

$$\text{?} \text{indicates text missing or illegible when filed}$$

Plugging in the values given in the problem and a damping ratio of 1, one gets:

$$ℛ = 2 \text{?} 1 \times {\sqrt{\frac{10 mH}{1.56 uF}}}^{\text{?}} \approx 160.13 Ω .$$

$$\text{?} \text{indicates text missing or illegible when filed}$$

Therefore, the minimum resistance value needed for the circuit to be overdamped is approximately 160.13Ω. FIG. 4D shows RLC series over-damping, illustrating an example of an overdamping response with 1 kΩ resistor.

### Frequency-Domain Approach With Wavelet Transforms

Wavelet-based techniques are a powerful tool for signal and image processing due to their ability to localize both frequency and spatial information simultaneously. The application of the multi-level discrete wavelet transform (DWT) combined with [symbol] 1-norm regularization is useful in enhancing sparsity in binary images. The discrete wavelet transform decomposes an image into approximation and detail coefficients at various scales. For a given binary image Ibin, we perform a four-level Haar wavelet decomposition, resulting in the approximation coefficients cAk and the detail coefficients (cHk, cVk, cDk), where k denotes the decomposition level:

$${I}_{bin} {\to }^{DWT} {\{ {cA}_{k} , ( {cH}_{k} , {cV}_{k} , {cD}_{k} ) \}}_{k = 1}^{4}$$

The [symbol] 1-norm based shrinkage function is applied to the detail coefficients to promote sparsity in the reconstructed image. The shrinkage function, commonly used in sparse coding, forces small coefficients toward zero, effectively removing less significant features from the image. The shrinkage function is defined as:

$${\hat{c}}_{detail} = sign ( {c}_{detail} ) \cdot max ( \vert {c}_{detail} \vert - {λ}_{{ℓ}_{1}} , 0 ) ,$$

where λ [symbol] 1 is the regularization parameter that controls the extent of sparsity. By applying this function to the high frequency detail coefficients cHk, cVk, and cDk, small coefficients have thresholds, leading to increased sparsity in the image after reconstruction. The role of [symbol] 1-norm regularization in this context is crucial for inducing sparsity, as it promotes zeroing out small coefficients, while preserving dominant features.

### Hybrid Digital/Analog Networks

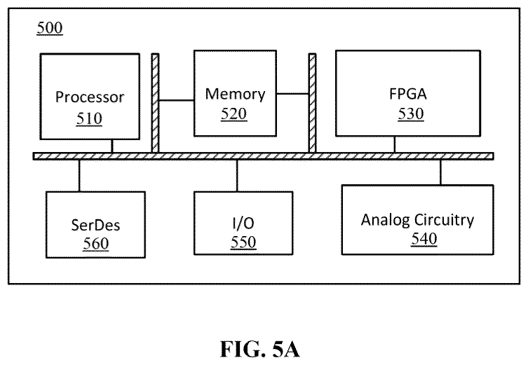

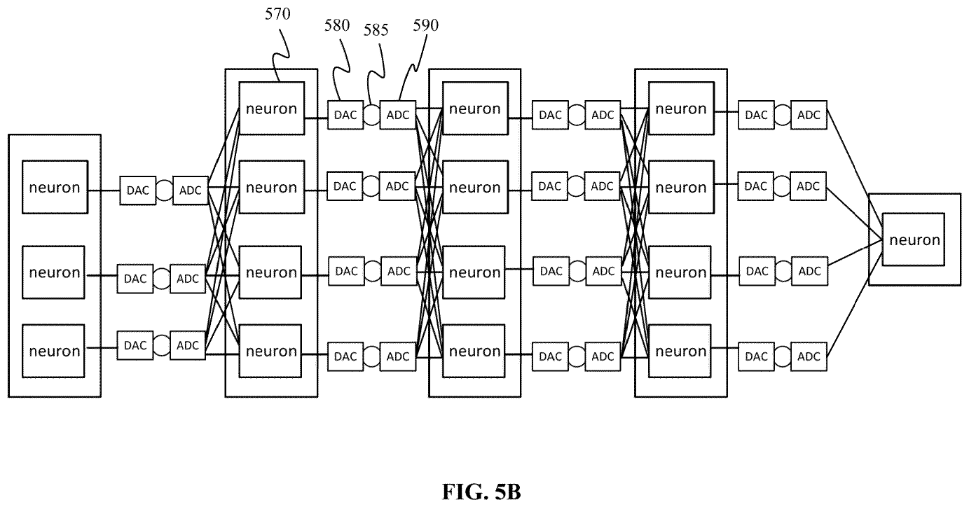

For a hybrid digital/analog approach, a spiking neural network (e.g., a neural network that includes a spike response function) can be implemented on a system on a chip (SoC). FIG. 5A illustrates an example hardware for a spiking neural network; and FIG. 5B shows an example representation of a neural network that can be implemented by the hardware of FIG. 5A. Referring to FIG. 5A, a SoC 500 can be used to implement a spiking neural network. SoC 500 integrates a processor 510 (e.g., one or more CPUs, GPUs, etc.), memory 520, FPGA 530 (or other accelerator), analog circuitry 540, and input/output interfaces 150. Such SoCs 500 can also include serializer/deserializer (SerDes) interface 560 for facilitating high-speed data transfer between the SoC 500 and other devices. The processor 510 and memory 520 provide computing resources, while the FPGA 530 offers programmable logic for network connectivity and processing functions. The I/O interfaces 550 allow interaction with the external world, such as receiving images for classification. The analog circuitry 540, composed of resistors, capacitors, and inductors (e.g., providing RC and RLC components as described above), realizes the spiking synapse models of the spike response functions (e.g., as shown in FIGS. 3A-3C and further described with respect to FIGS. 4A-4D). The analog circuitry 540 assists the FPGA 530 by offloading some network processing tasks, frecing up space on the FPGA 530 for neural network synthesis. In some embodiments, the analog circuity performs wavelet transforms based on biological systems (see FIG. 6D and FIG. 6E).

Referring to FIG. 5B, it can be seen that the example representation of the neural network of FIG. 1 can have layers of the neural network implemented in the FPGA with an output of a neuron 570 as implemented in the FPGA 530 converted to an analog signal by a digital to analog converter (DAC) 580 before passing through the spike model 585 for the spike response function as implemented by the analog circuitry 540. The output of the spike model 585 is then converted to a digital signal by an analog to digital converter (ADC) 590 for input to the next layer in the FPGA 530.

Compared to conventional digital SNN inference, the hybrid structure synthesizes the neural network and spike response functions, reducing look-up-table (LUT) usage.

The hybrid model enhances adaptability with features like Electrical Synapses and Neuromuscular Junctions, enabling drones (and other machines incorporating the described neural networks) to select suitable synapses during operations (e.g., drone package delivery).

For the fully analog artificial neural network, a resistive-processing unit forms the base of a neuron.

FIG. 6A shows an example representation of an analog neural network with spiking function; FIG. 6B shows an example implementation of a single voltage-based resistive processing unit (VRPU); FIG. 6C shows an example implementation of a voltage adder. FIG. 6D shows an example implementation for performing wavelet transforms. FIG. 6E shows an analog circuit for wavelet transforms consistent with FIG. 6D.

Referring to FIG. 6A, for cach neuron 600, multiple VRPU 610 outputs are combined together into a voltage adder 620. Additionally, since the bias term is a direct addition to the output of a neuron, the bias does not need to go through a VRPU and can be directly connected to the voltage adder 620. Thus, for a neuron with two inputs, p1 and p2, the output is computed as:

$${n}_{1}^{1} = {w}_{11}^{1} {p}_{1} {1}_{12}^{1} {p}_{2} + {b}_{1}^{1} .$$

Each VRPU can be implemented such as shown in FIG. 6B. In some cases, the voltage adder 620 is implemented as shown in FIG. 6C.

After the voltage adder, a spike response function circuit 630 is provided. Examples of spike response function circuit 630 are shown in FIGS. 3A-3C. Although not shown, a signal amplifier can be included between the VRPUs 610 and voltage adder 620.

Referring to FIG. 6B, a VRPU 610 is composed of three transistors with a capacitor, referred to as a 3T1C structure. In particular, a first PMOS transistor is coupled to receive a weight at its gate; a first NMOS transistor is coupled to receive the weight at its gate (e.g., VBP=VBN=a particular weight) and coupled by its drain to a drain of the first PMOS transistor. A first capacitor is coupled at a first end to the drains of the first NMOS transistor and the first PMOS transistor. A read PMOS transistor is coupled at its gate to the first end of the first capacitor. A load (e.g., resistor) is at a drain of the read PMOS transistor. A high pass filter is at the drain of the read PMOS transistor. In the 3T1C structure, the capacitor is responsible for storing the weights and two transistors as a NMOS and PMOS pair are designed to tune the weight of the capacitor. As the input signal is sent to the drain of the last transistor, the last transistor will multiply the input signal and the voltage on the capacitor to output the current at its source. Rather than directly using the output current, a load is designed (e.g., R1) such that the voltage at the drain of the last transistor can be used. The high pass filter is included to block the DC voltage. The illustrated VRPU 610 can be used to perform matrix multiplications at the heart of neural network computation.

Referring to FIG. 6D, a model of a cross-correlation circuit is shown. The model is of an analog signal processing circuit that shows a cross current mirror 631, one or more multipliers 632 coupled to the current mirror 631, one or more integrators 634 coupled to an output of the multiplier 632, and a comparator circuit 636 coupled to an output of the integrator 624 to compare with reference values.

The current mirror 631 converts the input current Iin into a mirrored current, ensuring proper scaling and biasing for the subsequent multiplication process.

For the multiplier 632, the TX_0° signal modulates the input current, effectively performing a multiplication operation. This multiplication mimics the wavelet basis function interaction with the input signal, used for wavelet decomposition. The TX_0° signal represents the fundamental frequency of interest and its interaction with Iin. As a result, the multiplier 632 generates frequency-selective signal components. In some cases, the multiplier 632 receives at an amplifier input of the current mirror 631 the output of the spike neuron. In this manner, the input to the amplifier input of the current mirror is an output of a spike neuron of a spiking neural network.

For the one or more integrators 634, common mode voltage (VCM) is introduced to stabilize the integration process and prevent DC drift. The RST (Reset) signal ensures periodic resetting of the integrator to avoid accumulation errors and to enable real-time signal processing.

The comparator circuit 636 receives oscillator input as the reference values. The oscillator input can be at a frequency for wavelets, allowing for perform wavelet transforms, enabling efficient time-frequency domain encoding in the spiking neural network. In some cases, the integrated output is compared against four reference voltages (Vref1, Vref2, Vref3, Vref4). Each Vref represents a threshold for detecting specific wavelet coefficients (LL, HL, LH, HH bands).

The comparator outputs can be processed through logic gates to combine decisions from different thresholds. The final logic output (Vout) provides a binary decision based on the presence or absence of significant wavelet components in the signal. FIG. 6E shows an analog circuit for one use case of the model of FIG. 6D. The cross-correlation circuit of FIG. 6E operates by first multiplying a set (e.g., four) of input signals, each corresponding to different frequency components used in the DWT, with the current mirror (631) output Icopy through the multiplier blocks. These inputs are denoted in FIG. 6E as TXf1, TXf2, TXf3, TXf4, where f1, f2, f3, f4 represent the four frequency bands used for wavelet analysis. The output of each multiplier 632 is subsequently fed into an integrator 634, which performs the time-domain accumulation of the signal products. The integrator 634 accumulates the signal over a period T, yielding an integrated voltage VIN that represents the correlation of the input signals over time, such that:

$${V}_{IN} ( \text{?} ) = {\int }_{0}^{T} ( {TX}_{{f}_{1}} \cdot {I}_{copy} + {TX}_{{f}_{2}} \cdot {I}_{copy} + {TX}_{{f}_{3}} \cdot {I}_{copy} + {TX}_{{f}_{4}} \cdot {I}_{copy} ) dt$$

$$\text{?} \text{indicates text missing or illegible when filed}$$

After the integration phase, the integrated signal is compared with several reference voltages Vref 1, Vref 2, Vref 3 using comparator circuits. The comparison process determines if the correlation exceeds predefined threshold levels. The comparator output is given by:

$${V}_{out} = \{ \begin{matrix}1 , & if {V}_{IN} > {V}_{ref} \\ 0 , & if {V}_{IN} \leq {V}_{ref}\end{matrix}$$

The outputs of the comparator circuit 636 are then passed through a logic block, which evaluates the final decision based on the multi-level threshold comparison. This final output, VOUT, indicates whether the cross-correlation meets the desired threshold for signal detection, making this circuit useful for applications in multi-level discrete wavelet transforms (DWT) for signal and image processing. The DWT is capable of localizing both frequency and spatial information, decomposing a signal into approximation and detail coefficients across various scales.

The inter-pixel distance function D: {(i,j)}×{(k,1)}→Z is defined that calculates the distance between two consecutive non-zero pixels in the image. Specifically, let bij=1 be the current pixel of interest. The distance to the next pixel with value 1 is given by:

$$𝒟 ( ( i , j ) , ( k , l ) ) = {{{min}_{k , l}}_{{b}_{kl} = 1}}_{( k , l ) \neq ( i , j )} \sqrt{{( k - i )}^{2} + {( l - j )}^{2}} .$$

The distance is accumulated across the entire image to characterize the image's sparsity. Formally, the sparsity S(B) of the image is defined as:

$$𝒮 ( B ) = {{\sum }_{i , j}}_{{b}_{ij} = 1} 𝒟 ( ( i , j ) , ( k , l ) ) .$$

The resulting value S(B) provides a quantitative measure of the image's sparsity, which reflects the distribution and separation of active pixels (where bij=1) across the image. This measure plays a critical role in optimizing the computational efficiency of further neural network operations by leveraging the inherent sparsity of the input data. Since higher image sparsity directly reduces the number of active pixels, it consequently decreases the number of computations and memory accesses required by the network, thus translating into significant energy savings.

While the arrangements of FIG. 6D and FIG. 6E are able to perform wavelet transformations in a variety of frequency-domain applications. As such, its implementations, uses cases, and scope are not limited to spiking neural networks or even to artificial neural networks.

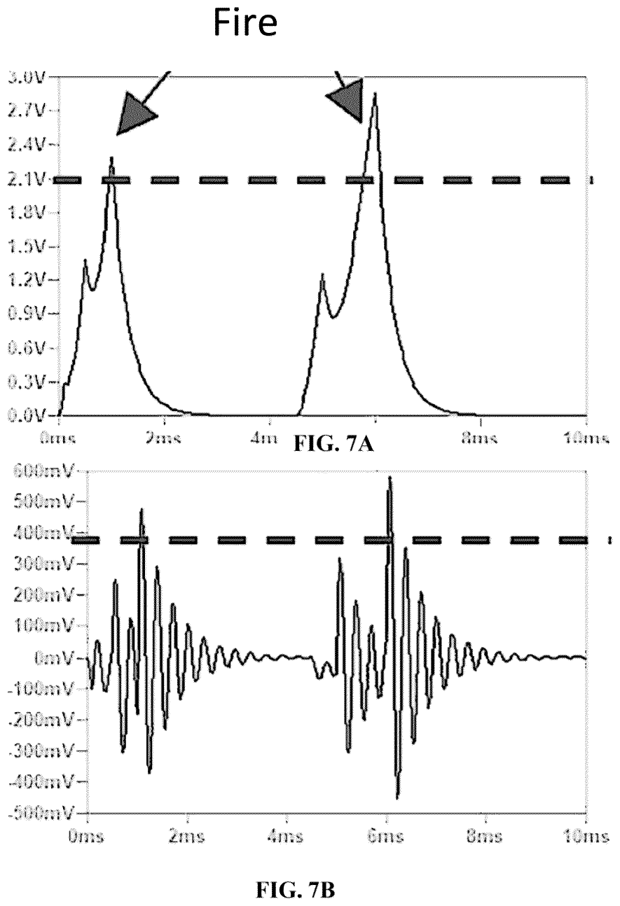

FIGS. 7A and 7B respectively illustrate fire responses for when the spike response function circuit is implemented as a LIF (FIG. 3C) and DE (FIG. 3A). Referring to FIG. 7A, the output diagram of the LIF circuit constructed using an RC circuit shows the peaks, which trigger a fire when exceeding the threshold (shown as dotted line). Similarly, referring to FIG. 7B, the output diagram of the DE circuit constructed using an RLC circuit shows the two peaks that trigger a fire when exceeding the threshold.

For fully connected layers of a neural network, there is no conversion needed in order to implement the layer incorporating the above-described SNN architecture. For a convolutional neural network (CNN) (and particularly the convolutional layers of the CNN), a conversion can be made to implement the neural network.

Turning now to an architecture incorporating a SNN, for example, the hybrid ANN-SNN architecture described above, to implement a convolutional neural network (CNN), each integrate and fire (IF) neuron in the neuron model (e.g., see LIF model of FIG. 3C) integrates the weighted inputs from the binary input stream and updates its membrane Vi(t) at each time step t as:

$${V}_{i} ( t ) = {V}_{i} ( t - 1 ) + {\sum }_{j ∈ {Γ}_{j}} {w}_{ij} {\sum }_{s ∈ {S}_{j}} {δ}_{j} ( t - s ) ,$$

Where wᵢⱼ indicates the synapse strength between neuron i and presynaptic neuron j. Sⱼ={sⱼ¹, sⱼ², . . . } contains the firing times of the neuron j, and Γⱼ contains all presynaptic neurons connected to the ith neuron. In CNN, the ReLU activation function of the ith neuron in the l-th layer is

$${a}_{l}^{i} = max ( 0 , {\sum }_{j = 1}^{{J}^{l - 1}} {W}_{ij}^{l} {a}_{j}^{l - 1} ) ,$$

Where J^{l-1} indicates the number of neurons in layer l−1 connected to neuron i in layer l. The above equation starts with a₀^{j}, representing the pixel value of the input image for CNN.

In the spiking CNN, each IF neuron integrates the sum of the weighted inputs spiking at each timing step t,

$${Z}_{i}^{l} ( t ) = {\sum }_{j = 1}^{{J}^{l - 1}} {W}_{ij}^{l} {\sum }_{s ∈ {S}_{j}} {δ}_{j}^{l - 1} ( t - s ) ,$$

And accumulates it into its membrane potential Vᵢ^{l} as shown in the neuron model.

Since the input pattern is presented T times with the time step dt, the firing rate of each IF neuron over the period Tdt is defined as

$${r}_{i}^{l} ( T ) = \frac{{N}_{i}^{l} ( T )}{Tdt} = \frac{{\sum }_{t = 1}^{T} {\sum }_{s ∈ {S}_{j}} {δ}_{j}^{l} ( t - s )}{T} {r}_{max} ,$$

Where Nᵢ^{l}(T) is the total number of spikes emitted by the ith neuron during the time period Tdt.

The time step dt is the minimum time unit for one spike commuting, which is decided by the circuit design or the configuration of the neuromorphic hardware. rₘₐₓ=1/dt (Hz) is the maximum firing rate.

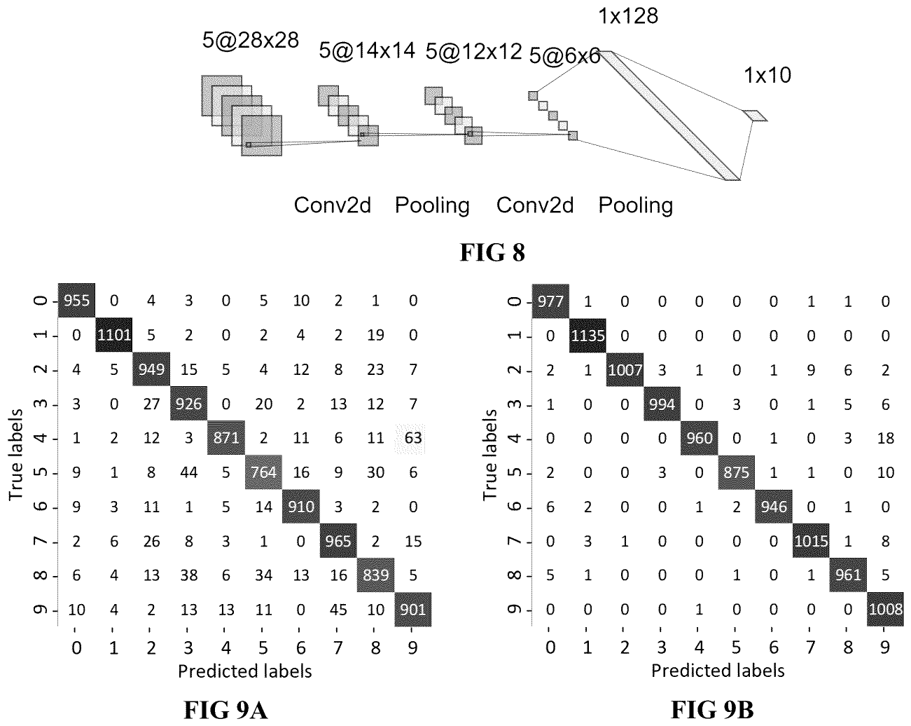

FIG. 8 illustrates an example artificial neural network architecture that can be converted to incorporate a spiking neural network. Referring to FIG. 8, the artificial neural network architecture is derived from a CNN by conversion. The architecture includes two convolutional layers, two average pooling layers, and two fully connected layers. In the illustrative example, the initial convolutional layer includes 32 filters, each with a 3×3 size, while the subsequent convolutional layer has 64 filters of identical dimensions. The average pooling layers employ a kernel size of 2×2. The first fully connected layer hosts 128 neurons, while the second fully connected layer accommodates 10 neurons, with each neuron representing a distinct class (e.g., for an image data set when used in an image classifier application). The spiking dynamics within the SNN, adaptable for the implementation of potential analog circuits, are governed by a spike response function derived from the Double Exponential (DE) model, Hodgkin-Huxley (HH) model, or Leaky Integrate-and-Fire (LIF) model.

The process of converting the artificial neural network architecture into a SNN can be performed as described above and the artificial neural network-SNN hybrid can be implemented in a system with an FPGA such as described with respect to FIG. 5A.

Indeed, FPGAs are a powerful hardware platform for implementing CNNs. The required Look-Up Tables (LUTs) for CNN implementation in an FPGA will depend on factors such as the number of filters, the input size, the kernel size, and the FPGA model. To determine the LUTs and Functional Elements (FEs) for SNN implementation on an FPGA, consider an SNN model that classifies CIFAR10 images (see e.g., FIG. 8). In this example, the neural network has two convolutional layers (Conv2d), two average pooling layers (Pooling), and two fully connected layers (see label of 1×128 and 1×10). The first layer has 4 filters (3×3), and the second has 8 filters. Average pooling uses a 2×2 kernel. The first fully connected layer has 128 neurons and the second has 10 neurons representing CIFAR10 classes. The resources for each layer are summated to determine the total.

For the first convolutional layer, the number of LUTs=36,864 and the number of FEs=4,096. For the second convolutional layer, the number of LUTs=73,728 and the number of FEs=2,048. For average pooling layers, the number of LUTs=256 and the number of FEs=0 (each). For the first fully connected layer, the number of LUTs=65,536 and the number of FEs=128. For the second fully connected layer, the number of LUTs=1,290 and the number of FEs=10. Based on this example implementation, the total LUTs required=112,394 and the total FEs required=6,538.

The occupancy ratio for small form-factor FPGAs is shown in Table 1 (below), indicating capacity limits for certain FPGA models. Further analysis focuses on hardware utilization of spike response functions. To achieve an exponential decay accuracy of 10⁻³ on FPGA, consider the Taylor series expansion:

$${e}^{- x} = 1 - x + \frac{{x}^{2}}{2 !} - \frac{{x}^{3}}{3 !} + \frac{{x}^{4}}{4 !} - …$$

truncate to the 7th term, needing 8 LUTs and 8 FEs for accurate computation. Implementing this function may sacrifice the size of the ANN by 10,320. If applied across all layer outputs, it might strain even the smallest FPGA models due to function complexity and high resource demand.

TABLE 1
Comparison of small form-factor FPGAs hardware resource occupation for an artificial
neural network before the spiking neural network spike response function.

| Model | Size (cm) | LUTs | FEs | LUTs(%) | FEs(%) | Release Year |
|---|---|---|---|---|---|---|
| Lattice iCE40UP5K | 0.7 × 0.7 × 0.5 | 5K | 5,280 | 2248% | 124% | 2018 |
| Xilinx Artix-7 | 2.7 × 2.7 × 0.95 | 215K | 33,650 | 52% | 19% | 2018 |
| Microchip MPF300TS | 6 × 6 × 1.2 | 300K | 75,264 | 37% | 9% | 2019 |
| Intel Cyclone 10 GX | 10 × 10 × 1.3 | 220K | 83,730 | 51% | 8% | 2019 |
| Lattice CertusPro-NX | 4 × 4 × 0.53 | 100K | 38,400 | 112% | 17% | 2021 |

As can be seen, there are limited hardware resources to run the SNN and the scale of the artificial neural network is limited to fully connected layers to make enough LUTs to run the spike response functions.

### Performance Evaluation—Image Classification

A Python script was crafted to simulate the Spike-Time Dependent Plasticity STDP learning rule, a critical mechanism in Spiking Neural Networks SNNs. Leveraging NumPy for numerical computations and Matplotlib for visualization, the code demonstrates how synaptic connections adapt based on the timing of pre- and post-synaptic spikes. STDP regulates synaptic strength in SNN, mimicking the behavior of biological neurons. Unlike traditional artificial neural networks, SNNs emulate the discrete spiking observed in the brain. STDP enables SNNs to adjust synaptic weights, crucial for learning patterns and producing accurate outputs.

The code initializes STDP parameters, generates random spike trains, and updates synaptic weights based on the spike timing difference. The STDP algorithm iterates through spikes, adjusting the weights accordingly. Positive and negative amplitude values determine weight updates, shaping network responses.

To evaluate the effectiveness of the proposed analog-aided SNN for image classification, tests were performed using the MNIST dataset. MNIST is a widely used data set in the field of computer vision for developing and testing machine learning models. MNIST is a dataset of handwritten 28×28 grayscale digits, with 60,000 training images, 10,000 testing images, and 10 classes (digits 0-9).

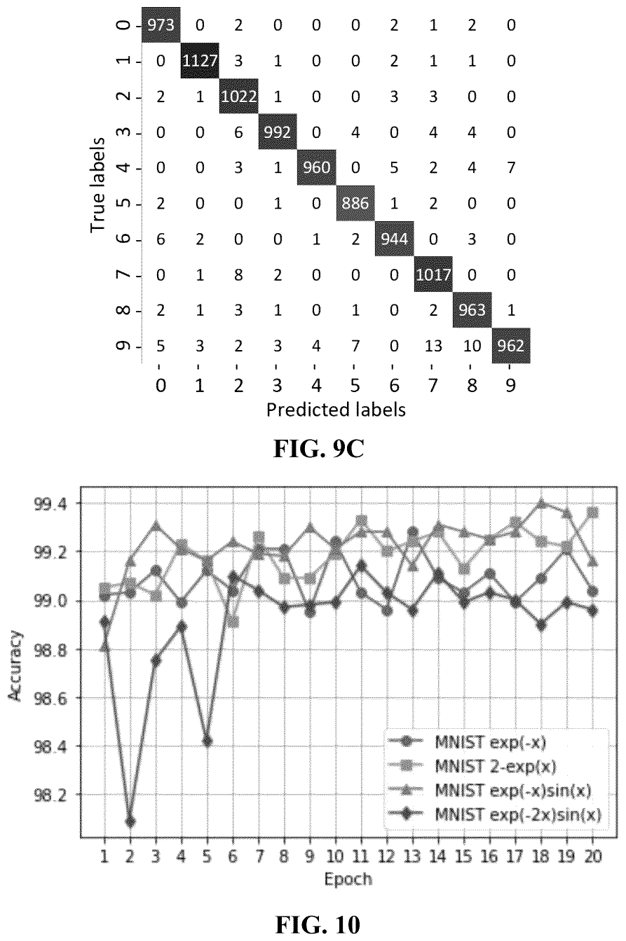

FIGS. 9A-9C present confusion matrices for comparison of a traditional SNN fully applied on a hardware-limited device with the proposed hybrid SNN on the MNIST dataset for image classification. With limited hardware resources to run the proposed analog-aided hybrid ANN-SNN, the scale of the ANN is limited to one layer fully connected ANN to make enough LUTs to also run the spike response functions in cases like FPGA chips Xilinx Artix 7, Microchip MPF300TS, and Intel Cyclone 10 GX.

FIG. 9A shows the performance of a SNN without analog help with limited FPGA hardware resources to run both the neural network and the impulse function. The accuracy of this configuration is 91.81%. FIG. 9B shows the performance of a SNN with analog help for the operation of 2−e^{-x}, using the impulse response of a charge RC circuit, and the limited FPGA hardware resources. The accuracy of this configuration is 98.78%. FIG. 9C shows the performance of a SNN with analog help for the operation of e^{-x} sin(x), using the impulse response of an underdamped RLC circuit, and the limited FPGA hardware resources. The accuracy of this configuration is 98.48%. In comparing FIGS. 9B and 9C (and with reference to FIG. 10 below), it can be seen that the hybrid SNN achieved an accuracy between 98% and 99% in the data set, with the proposed RC and RLC analog spike response functions delivering similar performance under the same threshold condition.

FIG. 10 shows the accuracy of the hybrid SNN using different spike response functions e^{-x}, 2−e^{-x}, e^{-x} sin(x), and e^{-2x} sin(x) on the MNIST dataset over 20 epochs. The accuracy is plotted against the number of epochs and each curve corresponds to a different spike response function. From the plot, it can be seen that all four spike response functions achieve high accuracy in the MNIST data set, with accuracies ranging from around 98.8% to 99.4%. However, there are some differences in the performance of the spike response functions over time. For example, the MNIST e^{-x} sin(x) curve starts with lower accuracy but gradually catches up to the other curves in later epochs. However, the MNIST e^{-2x} sin(x) curve has a relatively stable accuracy throughout the epochs.

To evaluate the effectiveness of the proposed analog-aided SNN (i.e., hybrid digital/analog implementation) for image classification, tests were also performed using the Canadian Institute for Advanced Research 10 (CIFAR10) dataset and Street View House Numbers (SVHN) dataset. The images in these datasets are sourced from the real world, representing various scenes and objects encountered in everyday life. CIFAR10 and SVHN datasets are widely recognized and used in the field of computer vision for the development and evaluation of machine learning models. CIFAR10 is a 32x32 color image dataset in 10 classes, with 50,000 training images and 10,000 testing images. Compared to SVHN, CIFAR10 images are more complex, making them a more challenging data set for machine learning models to learn and perform well. The SVHN dataset, as described by Netzer et al., is derived from house numbers captured in Google Street View images. This data set comprises 73,257 training images and 26,032 testing images, categorized into 10 classes, each corresponding to a digit from 0 to 9. The input images have dimensions of 32×32.

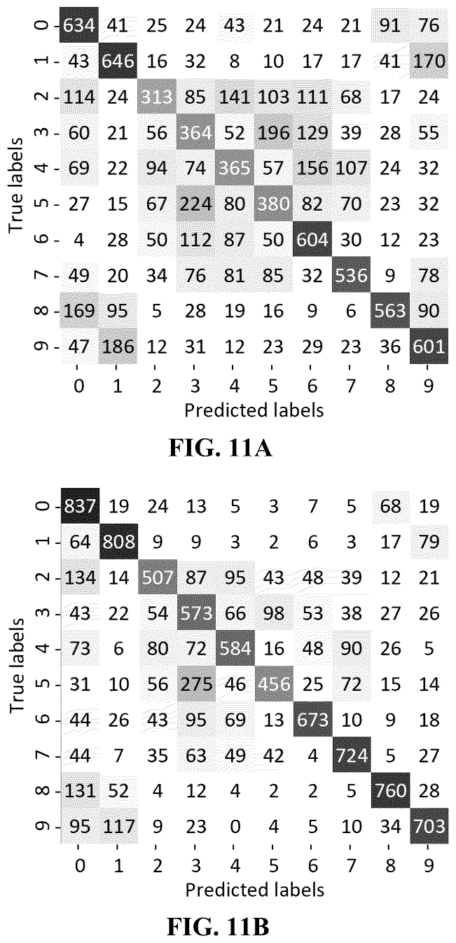

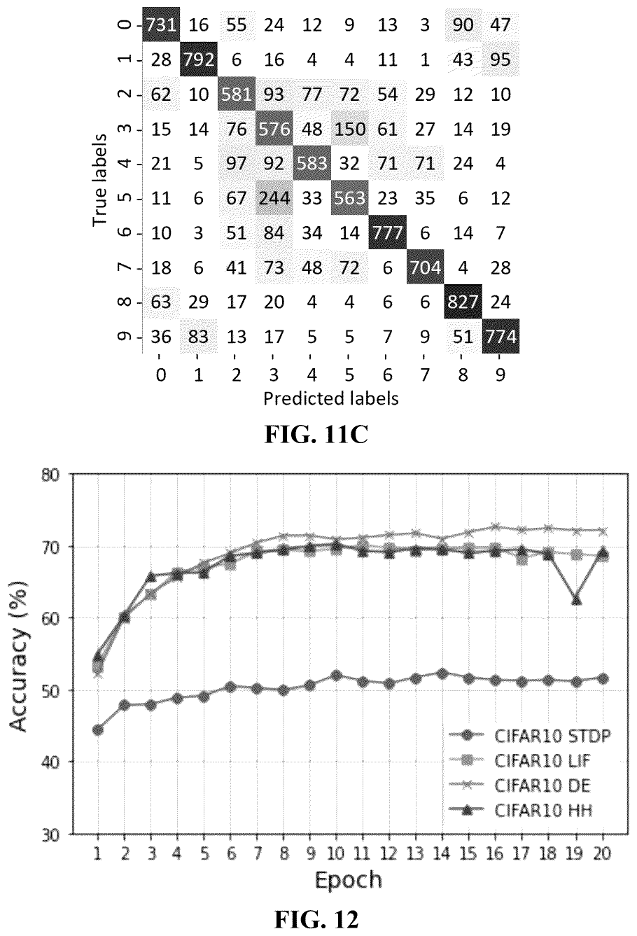

FIGS. 11A-11C present confusion matrices for comparison of a traditional SNN fully applied on a hardware-limited device with the proposed hybrid SNN on the CIFAR10 dataset for image classification. The matrix shows the number of correctly classified images and misclassified images for cach class.

FIG. 11A shows the performance of a SNN without analog help with limited FPGA hardware resources to run both the neural network and the impulse function. The accuracy of this configuration is 50%. FIG. 11B shows the performance of a SNN with analog help for the operation of 1−e^{-x}, using the impulse response of a charge RC circuit. The accuracy of this configuration is 66.25%. FIG. 11C shows the performance of a SNN with analog help for the operation of e^{-x} sin(x), using the impulse response of an underdamped RLC circuit. The accuracy of this configuration is 69.08%. In comparing FIGS. 11B and 11C (and with reference to FIG. 12 below), it can be seen that the hybrid SNN achieved an accuracy between 60% and 70% in the data set, with the proposed RC and RLC analog spike response functions delivering similar performance under the same threshold condition.

FIG. 12 shows the accuracy of the hybrid SNN over a pure digital STDP using different spike response functions on the CIFAR10 dataset over 20 epochs. In particular, FIG. 12 shows a plot of the accuracy of CIFAR10 dataset over epochs for pure digital STDP and three different analogs aided ANN-SNN models: LIF, DE, and HH.

The accuracy is plotted against the number of epochs, and each curve corresponds to a different spike response function. From the plot, it can be seen that the accuracy of the SNN increases as the number of epochs increases for all four spike response functions. However, the performance of the SNN using the DE model is slightly better than the other two spike response functions for most of the epochs, which shows the RLC analog-aided DE model of the spike response function is more suitable for object classification in object recognition.

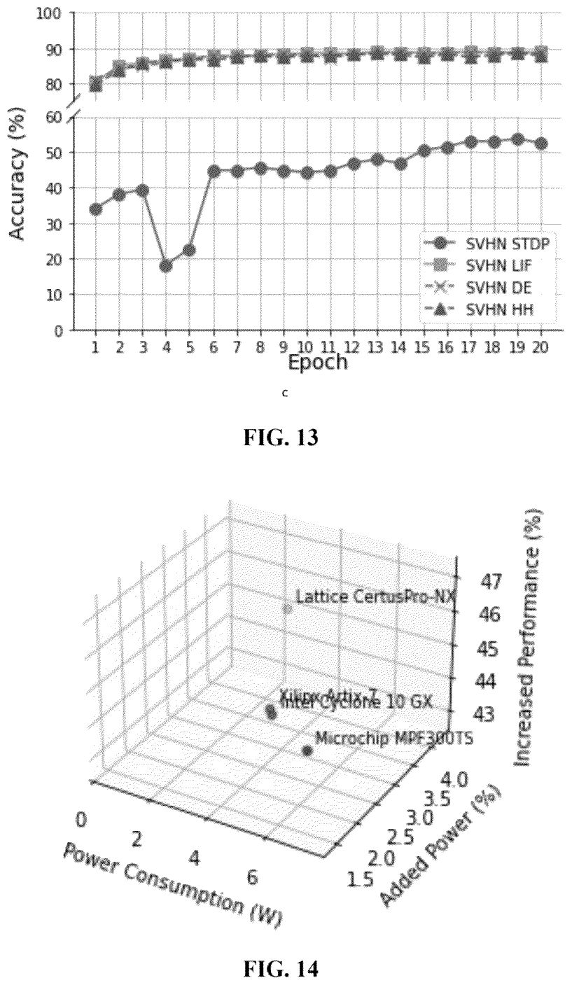

FIG. 13 shows the accuracy of the hybrid SNN over a pure digital STDP using different spike response functions on the SVHN dataset over 20 epochs. Referring to FIG. 13, it can be seen that all three analog-aided models achieve high accuracy on the SVHN dataset, with accuracies ranging from around 90%. From the results, the performance gap between the DE, LIF, and HH models is smaller than when using CIFAR10, and compared to the pure digital STDP running on FPGA, the improvement in analog ANN-SNN is even more significant.

FIG. 14 illustrates the comparison of power consumption, added power, and increased performance among various FPGAs that run ANN-SNN aided analogously with the SVHN dataset. The added power is less than 5% of the power consumed by the FPGA. However, due to the transition of spiking models from digital to analog, the accuracy performance is significantly around 45% for small FPGA models. These FPGA chips typically require only a few Watts to operate, whereas the analog-aided solution is estimated to increase power consumption by only a few tens of milliwatts.

To evaluate the effectiveness of the proposed fully analog SNN classifier, tests were performed using the Fashion MNIST dataset. The Fashion MNIST dataset provides a diverse collection of real-world fashion items, including clothing and accessories. It consists of a large set of 28×28 grayscale images, each representing a specific fashion item from 10 different classes. The uniqueness of this dataset lies in its diversity of clothing and accessory types, making it an ideal choice for evaluating the robustness and generalization capabilities of the analog SNN classifier.

For the evaluation, the SNN model is defined with spiking behavior of the RLC passive circuit parameters acquired from LTSpice. The neural network architecture is based on the example shown in FIG. 6A and has two fully connected layers where the first layer has 784 input neurons, which corresponds to the flattened input images of size 28×28 pixels, and the second layer has 10 output neurons, representing the number of classes in the Fashion MNIST dataset. In this example, the depicted ANN architecture is tailored to classify fashion product images. Fashion product images serve as the inputs, and the network's output comprises various product classes. The design of an artificial neuron commences with the foundation of a Resistive-Processing Unit (RPU) and subsequently implements necessary adaptations for practical applicability. In the context of artificial neural networks, an artificial neuron (e.g., neuron 600 of FIG. 6A) operates as follows: Given a weights matrix denoted as w and an input vector xin, it performs a mapping to yield an output represented as

$${x}_{out} \text{?} = σ ( {w}^{T} {x}_{in} \text{?} b ) .$$

$$\text{?} \text{indicates text missing or illegible when filed}$$

Here, the variable b signifies the bias vector and the function σ embodies a non-linear activation or a spike response (e.g., as implemented by one of the models shown in FIGS. 3A-3C).

The VRPU design (e.g., as shown in FIG. 6B) incorporates a Voltage-Controlled Current Source (VCCS), offering distinct advantages. Firstly, it obviates the need for precise control of the DC biasing voltage on each node to ensure the proper operation of the MOSFET. Secondly, it enhances the precision of the multiplication operation. The variables VBP and VBN represent the tuning signals for network weights, which are obtained through offline training and subsequently stored in the weights memory. Subsequently, these weight values are directed into the equivalent circuit load element R1. In the single neuron structure, multiple VRPU outputs are combined together into a voltage adder (e.g., voltage adder 620 of FIG. 6C). For a neuron with two-inputs, p1 and p2, the output is computed as,

$$\text{?} \text{?} {w}_{11}^{1} \text{?} + \text{?} {p}_{2} + \text{?} .$$

$$\text{?} \text{indicates text missing or illegible when filed}$$

Multiple neurons constitute a layer, and k layers form the entire classifier.

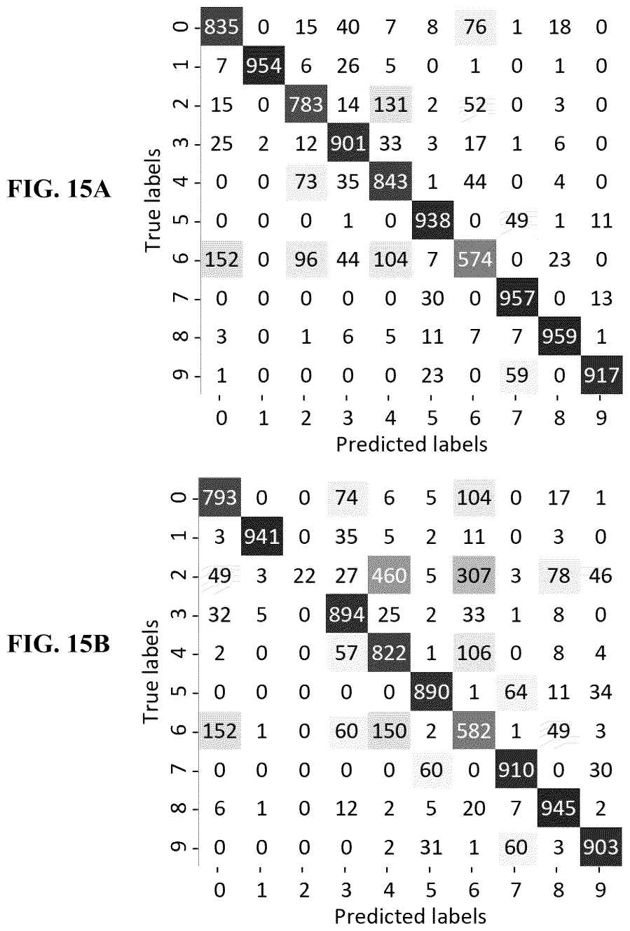

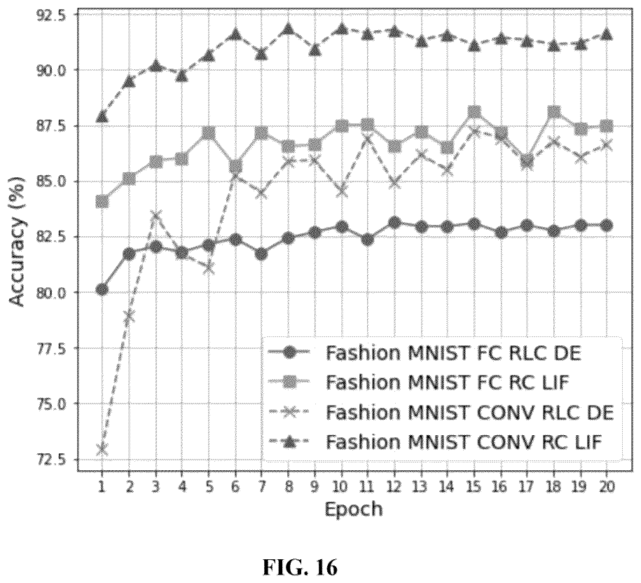

FIGS. 15A and 15B show confusion matrices for Fashion MNIST image classification using an analog SNN to operate impulse responses of RC circuits and underdamped RLC circuit, respectively. In the plots, each row of the matrix represents the instances in the actual class, while each column represents the instances in the predicted class. FIG. 16 shows the accuracy of the analog SNN with various spike response functions on the Fashion MNIST dataset over 20 epochs.

FIG. 15A shows a plot for an analog SNN with the resonant circuit for operation of 1−e^{-x}, using the impulse response of a RC circuit. The accuracy for this case is 85.45%. In addition, the precision, recall, and F1-score are all above 0.85, indicating a strong balance between correctly identifying positive and negative instances in the classification task. The confusion matrix further shows that the model has effectively classified the different fashion items. FIG. 15B shows a plot for an analog SNN with the resonant circuit for operation of e^{-x} sin(x), using the impulse response of an underdamped RLC circuit. The accuracy for this case is 77.02%, which is lower than the accuracy for the SNN LIF model. In addition, the SNN DE model has a lower precision, recall, and F1-score, indicating that it is not as effective in correctly classifying the fashion items in the dataset. The confusion matrix for the SNN DE model reveals some misclassifications and lower performance than the SNN LIF model shown in FIG. 15A.

As can be seen in FIG. 16, the LIF and DE models exhibited similar performance, as cach model's classification accuracy evolves over multiple epochs of training, with comparable accuracy, precision, recall, and F1-score in structurally similar SNN. Both models were capable of correctly classifying all ten different objects. However, to make a fair comparison between the LIF and DE analog methods, it is noted that there is a difference in the area occupied by passive components. Unlike resistors, capacitors and inductors typically require larger areas. This discrepancy in size can be attributed to the physical characteristics of these passive components, including the need for coiled wire in inductors and the dielectric material in capacitors. For instance, a 10 mH inductor may occupy approximately 7.8 mm×10 mm in size, while a 1.5 μF capacitor measures about 10 mm×17 mm in the same technology node. Consequently, on the same PCB board area, the fully connected layer that can be implemented in the DE analog approach is only half the size compared to LIF.

The graph of FIG. 16 clearly demonstrates that, when considering the same physical footprint of electronic components, the RC LIF model consistently outperforms the RLC DE model for fully connected layer structures, as depicted by the solid lines in the graph.

FIG. 16 also shows the classification performance with convolutional processing units. The performance of the RC LIF model and RLC DE model is depicted using dashed lines. Notably, we observe that the RLC DE model, when equipped with convolutional layers, exhibits a steadily increasing accuracy with the number of epochs, approaching the performance of the RC LIF model when using fully connected layers. Furthermore, the RC LIF model with convolutional layers outperforms with an accuracy exceeding 90% consistently.

Table 2 presents a comparison of classification models applied to the Fashion MNIST dataset, showcasing their respective test accuracies.

| Model (Method) | Test Accuracy |
|---|---|
| Decision Tree Classifier | 79.8% |
| Analog FC SNN DE (this work) | 82.6% |
| Analog CNN SNN DE (this work) | 86.3% |
| Three-layer FC Neural Network | 87.2% |
| Analog FC SNN LIF (this work) | 87.5% |
| Evolutionary Deep Learning Framework | 90.6% |
| CNN using ReLu activation function | 90.7% |
| Analog CNN SNN LIF (this work) | 91.2% |
| CNN using Softmax activation function | 91.9% |
| CNN with Batch Normalization | 92.2% |

As can be seen, among the traditional approaches, the Decision Tree Classifier exhibits the lowest accuracy at 79.8%, followed by the Three-layer Neural Network at 87.2%. The Support Vector Classifier with an RBF kernel achieves a higher accuracy of 89.7%, while the Evolutionary Deep Learning Framework achieves 90.6%. Further, employing advanced techniques, the CNN using SVM activation function attains a test accuracy of 90.7%. Comparatively, the analog methods introduced in this work demonstrate competitive performance with existing techniques. The Analog FC SNN DE achieves a test accuracy of 82.55%, while the Analog FC SNN LIF reaches 87.5%. The Analog CNN SNN DE performs at 86.3%, and the Analog CNN SNN LIF excels at 91.2%, exhibiting results that are compatible with or surpass those of traditional digital methods.

### SNN Substrates

In some cases, the SNN circuitry can utilize magnetic tunnel junction devices.

Spike-based computing, often implemented with Magnetic Tunnel Junctions (MTJs), represents a branch of neuromorphic computing that aims to emulate the asynchronous and event-driven characteristics of biological neural networks. This paradigm seeks to create computer systems that operate in a brain-like manner, enabling highly efficient data processing.

MTJs, as a form of magnetic memory device, play a pivotal role in this approach. They offer non-volatility, excellent scalability, and low power consumption, making them invaluable components. MTJs are frequently employed in the construction of artificial neurons and synapses, contributing significantly to the development of more efficient and compact neuromorphic systems.

In some cases, the SNN circuitry can utilize a combination of MTJ and CMOS devices. The field of neuromorphic computing is witnessing innovative research strides, with a keen interest in integrating Magnetic Tunnel Junctions (MTJs) with Complementary Metal Oxide Semiconductor (CMOS) technology. This hybrid MTJ-CMOS approach aims to harness the strengths of both technologies, thereby creating an efficient and high-performance neuromorphic computing platform. For instance, consider a neuromorphic system designed for AI applications like machine learning or neural network algorithms. The MTJ-CMOS hybrid system could offer a unique blend of MTJs' non-volatility and energy efficiency with the computational robustness and maturity of CMOS technology, thus delivering an improved computational solution. The marriage of MTJs and CMOS technology can present a host of advantages. With MTJs' non-volatility and low power requirements, coupled with the processing capabilities of CMOS circuits, the resulting hybrid system can exhibit increased energy efficiency, data density, and overall system performance.

### Additional Machine Learning Methods

In addition to the architectures presented herein, the described SNNs can be incorporated into architectures including, but not limited to, folded neural networks (FNNs) (e.g., analog neural networks with circuitry for a layer that is reused for multiple consecutive layers), recurrent neural networks (RNNs) (e.g., including with a fixed, randomly connected network, “reservoir”, that processes input data, also referred to as Reservoir Computing), light-weight neural networks, semi-randomized neural networks, partially untrained structured networks, and unconventional computing.

Reservoir computing enables efficient computation through linear transformations and involves training only the output weights.

Lightweight neural network architectures aim to reduce computational complexity and memory requirements while maintaining performance. Methods such as model pruning, weight quantization, and knowledge distillation are employed to create lightweight networks. Examples of lightweight neural network architectures that may benefit from incorporating a spiking neural network as described herein include SqueezeNet (developed by DeepScale, University of California Berkeley, and Stanford University), MobileNet (developed by Google), ShuffleNet (proposed by the Face++ team), and Xception (developed by Google).

Semi-randomized neural networks are neural networks with partially randomized connections or weights, which introduce controlled randomness to enhance generalization and robustness.

Partially untrained structured networks are neural networks where only a portion of the network is trained, while the remaining structure is fixed or initialized in a specific way.

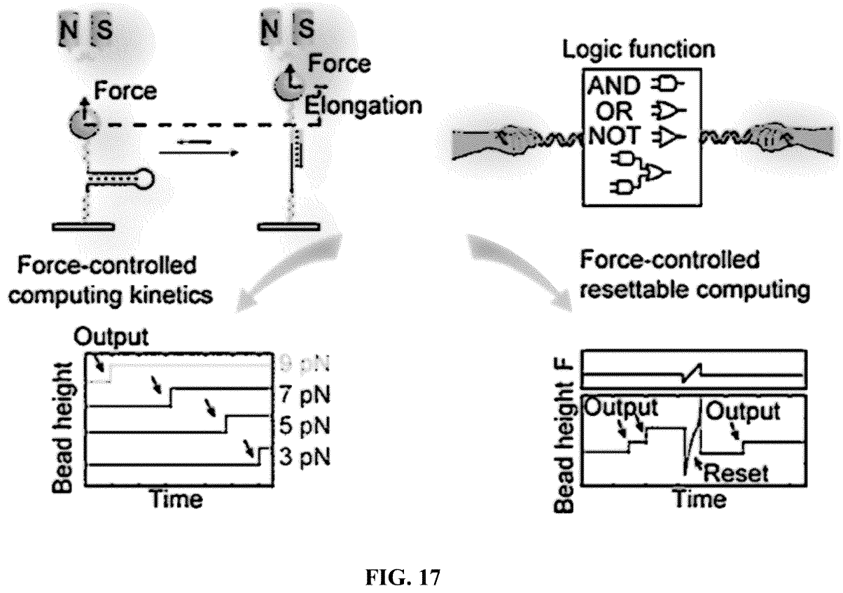

Unconventional computing includes approaches that explore unconventional hardware or computational paradigms, such as memristors, quantum computing, or DNA computing, for implementing neural networks. FIG. 17 shows a schematic illustration of a force-controlled resettable single-molecule DNA computing system, which provides a new paradigm for implementing neural networks and neuromorphic computing.

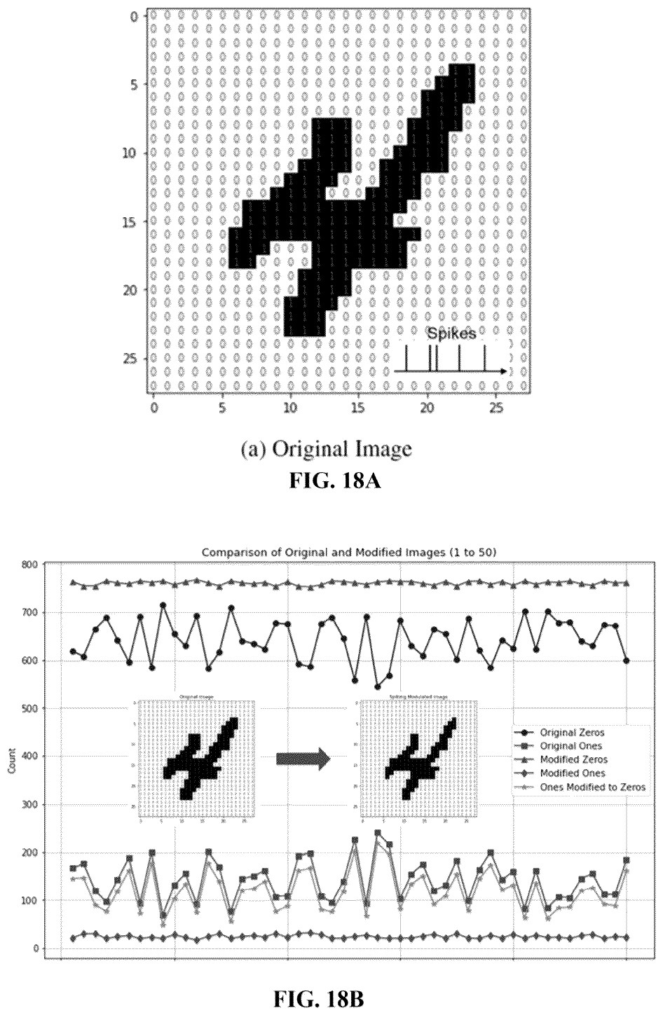

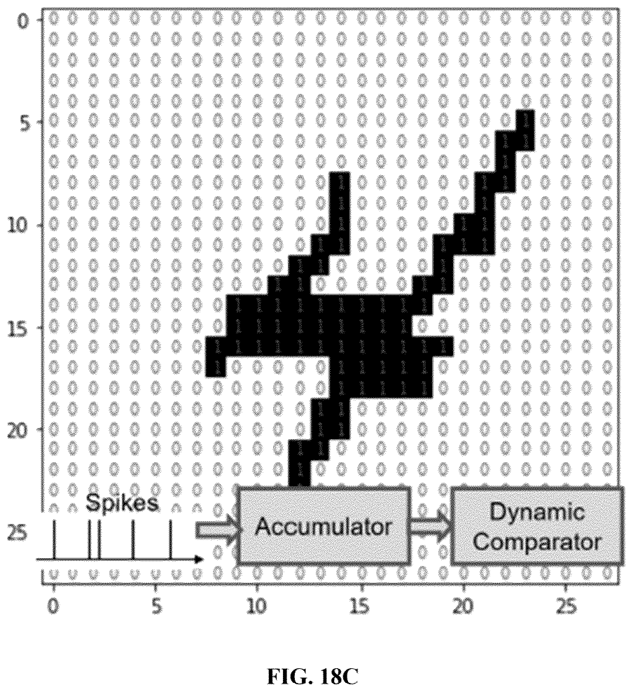

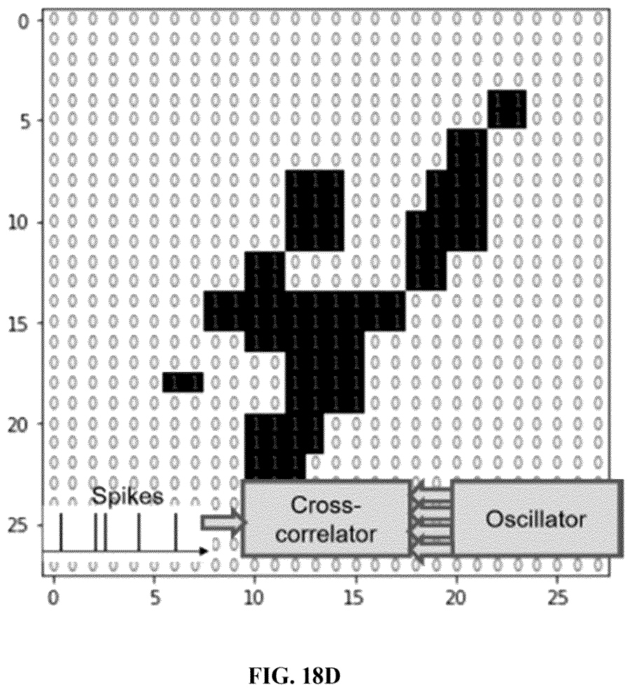

FIG. 18A shows the original MNIST image. FIG. 18C presents the spiking-modulated image using the traditional LIF model (see FIG. 6A). The LIF model excels at capturing the backbone of the image, especially in denser regions, while maintaining continuity in the structure. In contrast, FIG. 18D (see FIG. 6D and FIG. 6E) illustrates the wavelet-transformed image with [symbol] 1-norm regularization, which is more effective at noise reduction while still preserving the overall shape of the image.

FIG. 18B compares the original and spiking-modulated images across 50 samples from the MNIST dataset. The chart tracks the counts of binary pixel values (0's and 1's) before and after spiking modulation. In the left panel, the pixel distribution for the original image is shown, while the right panel illustrates the effects of the LIF transformation. This transformation selectively reduces certain consecutive “1”s that do not meet the threshold, converting them to “0”s, which increases image sparsity. By comparing the number of 1's and 0's before and after modification, we observe that the energy savings from the LIF approach vary across different images, as evidenced by the 50-image analysis in this experiment.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A neural network circuit, comprising:
a spiking neural network, wherein each neuron of the spiking neural network comprises a RC or RLC circuit formed of passive elements.

2. The neural network circuit of claim 1, wherein a portion of each neuron of the spiking neural network is implemented in a digital processor and further includes a digital to analog converter between the portion implemented in the digital processor and the RC or RLC circuit.

3. The neural network circuit of claim 2, wherein the digital processor is a FPGA.

4. The neural network circuit of claim 1, wherein the spiking neural network is implemented as a fully analog neural network.

5. The neural network circuit of claim 4, wherein each neuron of the spiking neural network further comprises an array of voltage-based resistive processing units (VRPUs) and a voltage adder coupled to receive outputs of the array of VRPUs and a bias, wherein the RC or RLC circuit is coupled to receive an output of the voltage adder.

6. The neural network circuit of claim 5, wherein each VRPU comprises:
a first PMOS transistor coupled to receive a weight at its gate;
a first NMOS transistor coupled to receive the weight at its gate and coupled by its drain to a drain of the first PMOS transistor;
a first capacitor coupled at a first end to the drains of the first NMOS transistor and the first PMOS transistor;
a read PMOS transistor coupled at its gate to the first end of the first capacitor;
a load at a drain of the read PMOS transistor; and
a high pass filter at the drain of the read PMOS transistor.

7. The neural network circuit of claim 1, wherein the RC or RLC circuit is a RC circuit implementing a HH model.

8. The neural network circuit of claim 1, wherein the RC or RLC circuit is a RC circuit implementing a LIF model.

9. The neural network circuit of claim 1, wherein the RC or RLC circuit is a RLC circuit implementing a DE model.

10. The neural network circuit of claim 1, wherein the neural network circuit comprises a convolutional neural network.

11. The neural network circuit of claim 1, wherein the neural network circuit comprises a recurrent neural network for reservoir computing.

12. The neural network circuit of claim 1, wherein the neural network circuit comprises a lightweight neural network.

13. The neural network circuit of claim 1, wherein the neural network circuit comprises a semi-randomized neural network.

14. The neural network circuit of claim 1, wherein the neural network circuit comprises a partially untrained structure network.

15. The neural network circuit of claim 1, wherein the neural network circuit comprises a force-controlled resettable single-molecule DNA computing system.

16. The neural network circuit of claim 1, wherein the spiking neural network is formed using magnetic tunnel junction devices.

17. The neural network circuit of claim 1, wherein the spiking neural network is formed using magnetic tunnel junction devices and complementary metal oxide semiconductor devices.

18. An analog signal processing circuit, comprising:
a current mirror;
a multiplier coupled to the current mirror and receiving an input at an amplifier input of the current mirror;
an integrator coupled to an output of the multiplier; and
a comparator circuit coupled to an output of the integrator to compare with reference values.

19. The analog signal processing circuit of claim 18, wherein the input to the amplifier input of the current mirror is an output of a spike neuron of a spiking neural network.

20. The analog signal processing circuit of claim 19, wherein the comparator circuit receives oscillator input as the reference values.
